(19) United States
(12) Patent Application Publication
(10) Pub. No.: US 2024/0220240 A1
(43) Pub. Date: Jul. 4, 2024

(54) METHOD AND SYSTEM FOR MANAGING PERSONALIZED CODE STYLING

(71) Applicant: JPMorgan Chase Bank, N.A., New York, NY (US)

(72) Inventors: Jonathan SIMON, Herzliya (IL); Mark GEYZER, Maale Adumim (IL)

(73) Assignee: JPMorgan Chase Bank, N.A., New York, NY (US)

(21) Appl. No.: 18/092,686

(22) Filed: Jan. 3, 2023

(51) Int. Cl. G06F 8/77; G06F 8/71

(52) U.S. Cl. CPC G06F 8/77; G06F 8/71

(57) ABSTRACT

A method for managing personalized code formatting to facilitate collaborative software development is disclosed. The method includes receiving, via a graphical user interface, preferences from a first user, the preferences corresponding to a code styling preference of the first user; configuring a software development platform that corresponds to the first user based on the preferences; detecting a code pull request from the first user, the code pull request including a first request to pull a code set from a code repository to the software development platform; converting, in real-time, the code set to a display data set based on the preferences; and displaying, via the software development platform, the display data set for the first user.

### BACKGROUND

### 1. Field of the Disclosure

This technology generally relates to methods and systems for managing code, and more particularly to methods and systems for managing personalized code styling to provide custom code formatting for each developer in an integrated development environment.

### 2. Background Information

Many software developers are highly opinionated when it comes to styling preferences for software codes. Often, when a developer reads software codes that were written in a coding style that is different than what they prefer, the different coding style may cause the developer difficulties in understanding the intent and/or semantics of the software codes. As such, it may take a considerable amount of time for the developer to become acclimated with the different coding style or a considerable number of resources for the developer to modify/convert the software codes to a preferred style. Historically, implementations of conventional code styling management techniques have resulted in varying degrees of success with respect to facilitating collaborative software development for multiple developers.

One drawback of using the conventional code styling management techniques is that in many instances, a standard style is often set for shared code repositories to ensure project consistency. As a result, many developers will be uncomfortable with the standard style and unsatisfied with having to work in a style that they do not prefer. Additionally, different teams of developers may choose to commit software codes to the shared code repositories with differing/contradicting code styles which results in inconsistent and messy code repositories.

Therefore, there is a need for a personalized code styling solution that automatically converts software code from one style to another for each developer based on a corresponding style preference whenever the software code is pulled from or pushed to the shard code repositories.

### SUMMARY

The present disclosure, through one or more of its various aspects, embodiments, and/or specific features or sub-components, provides, inter alia, various systems, servers, devices, methods, media, programs, and platforms for managing personalized code styling to provide custom code formatting for each developer in an integrated development environment.

According to an aspect of the present disclosure, a method for managing personalized code formatting to facilitate collaborative software development is disclosed. The method is implemented by at least one processor. The method may include receiving, via a graphical user interface, at least one preference from a first user, the at least one preference may correspond to a code styling preference of the first user; configuring a software development platform that corresponds to the first user based on the at least one preference; detecting at least one code pull request from the first user, the at least one code pull request may include a first request to pull a code set from a code repository to the software development platform; converting, in real-time, the code set to a display data set based on the at least one preference; and displaying, via the software development platform, the display data set for the first user.

In accordance with an exemplary embodiment, the method may further include detecting at least one code upload request from the first user, the at least one code upload request may include a second request to upload the display data set from the software development platform to the code repository; retrieving at least one repository preference from the code repository, the at least one repository preference may correspond to a standard code styling preference of the code repository; converting, in real-time, the display data set to a standard format data set based on the at least one repository preference; and persisting the standard format data set in the code repository.

In accordance with an exemplary embodiment, the method may further include receiving, via the graphical user interface, a new standard code styling preference from a second user, the new standard code styling preference may relate to a code format that is determined based on at least one from among a business guideline, an operational guideline, and a regulatory guideline; and automatically updating the at least one repository preference of the code repository based on the new standard code styling preference.

In accordance with an exemplary embodiment, to receive the at least one preference from the first user via the graphical user interface, the method may further include displaying, via the graphical user interface, at least one prompt for the first user; receiving, via the graphical user interface, at least one input from the first user in response to the at least one prompt; determining whether additional information is required from the first user based on the at least one input; and displaying, via the graphical user interface, at least one subsequent prompt for the first user when additional information is required.

In accordance with an exemplary embodiment, to convert the code set to the display data set, the method may further include identifying at least one translation tool that corresponds to the software development platform from a plurality of translation tools; parsing the code set to identify at least one element, the at least one element may relate to at least one from among an alphanumeric character, a spacing character, and a symbol that make up the code set; mapping, via the identified at least one translation tool, each of the at least one element; and generating, via the identified at least one translation tool, the display data set based on a result of the mapping.

In accordance with an exemplary embodiment, the at least one translation tool may be identified based on the at least one preference of the first user and at least one characteristic of the code set, the at least one characteristic may include a code type characteristic.

In accordance with an exemplary embodiment, the method may further include generating at least one log file, the at least one log file may include information that relates to at least one from among the identified translation tool, the at least one element, the mapping, and the generated display data set; and associating the at least one log file together with the first user.

In accordance with an exemplary embodiment, the code styling preference may include at least one from among an indentation preference, a spacing around operators preference, a blank lines preference, a comment lines preference, and a line length preference.

In accordance with an exemplary embodiment, the method may further include associating the at least one preference with the first user; automatically detecting, based on a user login, usage of a new software development platform by the first user; and automatically configuring the new software development platform for the first user based on the at least one preference.

According to an aspect of the present disclosure, a computing device configured to implement an execution of a method for managing personalized code formatting to facilitate collaborative software development is disclosed. The computing device including a processor; a memory; and a communication interface coupled to each of the processor and the memory, wherein the processor may be configured to receive, via a graphical user interface, at least one preference from a first user, the at least one preference may correspond to a code styling preference of the first user; configure a software development platform that corresponds to the first user based on the at least one preference; detect at least one code pull request from the first user, the at least one code pull request may include a first request to pull a code set from a code repository to the software development platform; convert, in real-time, the code set to a display data set based on the at least one preference; and display, via the software development platform, the display data set for the first user.

In accordance with an exemplary embodiment, the processor may be further configured to detect at least one code upload request from the first user, the at least one code upload request may include a second request to upload the display data set from the software development platform to the code repository; retrieve at least one repository preference from the code repository, the at least one repository preference may correspond to a standard code styling preference of the code repository; convert, in real-time, the display data set to a standard format data set based on the at least one repository preference; and persist the standard format data set in the code repository.

In accordance with an exemplary embodiment, the processor may be further configured to receive, via the graphical user interface, a new standard code styling preference from a second user, the new standard code styling preference may relate to a code format that is determined based on at least one from among a business guideline, an operational guideline, and a regulatory guideline; and automatically update the at least one repository preference of the code repository based on the new standard code styling preference.

In accordance with an exemplary embodiment, to receive the at least one preference from the first user via the graphical user interface, the processor may be further configured to display, via the graphical user interface, at least one prompt for the first user; receive, via the graphical user interface, at least one input from the first user in response to the at least one prompt; determine whether additional information is required from the first user based on the at least one input; and display, via the graphical user interface, at least one subsequent prompt for the first user when additional information is required.

In accordance with an exemplary embodiment, to convert the code set to the display data set, the processor may be further configured to identify at least one translation tool that corresponds to the software development platform from a plurality of translation tools; parse the code set to identify at least one element, the at least one element may relate to at least one from among an alphanumeric character, a spacing character, and a symbol that make up the code set; map, via the identified at least one translation tool, each of the at least one element; and generate, via the identified at least one translation tool, the display data set based on a result of the mapping.

In accordance with an exemplary embodiment, the processor may be further configured to identify the at least one translation tool based on the at least one preference of the first user and at least one characteristic of the code set, the at least one characteristic may include a code type characteristic.

In accordance with an exemplary embodiment, the processor may be further configured to generate at least one log file, the at least one log file may include information that relates to at least one from among the identified translation tool, the at least one element, the mapping, and the generated display data set; and associate the at least one log file together with the first user.

In accordance with an exemplary embodiment, the code styling preference may include at least one from among an indentation preference, a spacing around operators preference, a blank lines preference, a comment lines preference, and a line length preference.

In accordance with an exemplary embodiment, the processor may be further configured to associate the at least one preference with the first user; automatically detect, based on a user login, usage of a new software development platform by the first user; and automatically configure the new software development platform for the first user based on the at least one preference.

According to an aspect of the present disclosure, a non-transitory computer readable storage medium storing instructions for managing personalized code formatting to facilitate collaborative software development is disclosed. The storage medium including executable code which, when executed by a processor, may cause the processor to receive, via a graphical user interface, at least one preference from a first user, the at least one preference may correspond to a code styling preference of the first user; configure a software development platform that corresponds to the first user based on the at least one preference; detect at least one code pull request from the first user, the at least one code pull request may include a first request to pull a code set from a code repository to the software development platform; convert, in real-time, the code set to a display data set based on the at least one preference; and display, via the software development platform, the display data set for the first user.

In accordance with an exemplary embodiment, when executed by the processor, the executable code may further cause the processor to detect at least one code upload request from the first user, the at least one code upload request may include a second request to upload the display data set from the software development platform to the code repository; retrieve at least one repository preference from the code repository, the at least one repository preference may correspond to a standard code styling preference of the code repository; convert, in real-time, the display data set to a standard format data set based on the at least one repository preference; and persist the standard format data set in the code repository.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for managing personalized code styling to provide custom code formatting for each developer in an integrated development environment.

FIG. 4 is a flowchart of an exemplary data pull process for implementing a method for managing personalized code styling to provide custom code formatting for each developer in an integrated development environment.

FIG. 5 is a flowchart of an exemplary data upload process for implementing a method for managing personalized code styling to provide custom code formatting for each developer in an integrated development environment.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

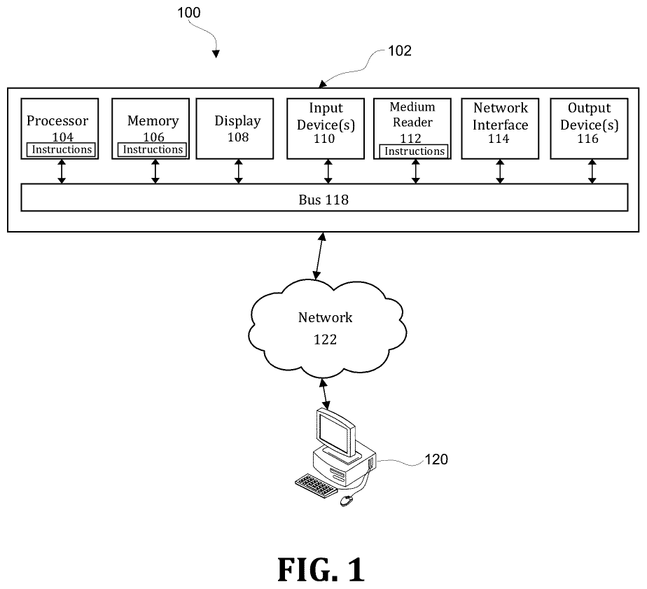

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for managing personalized code styling to provide custom code formatting for each developer in an integrated development environment.

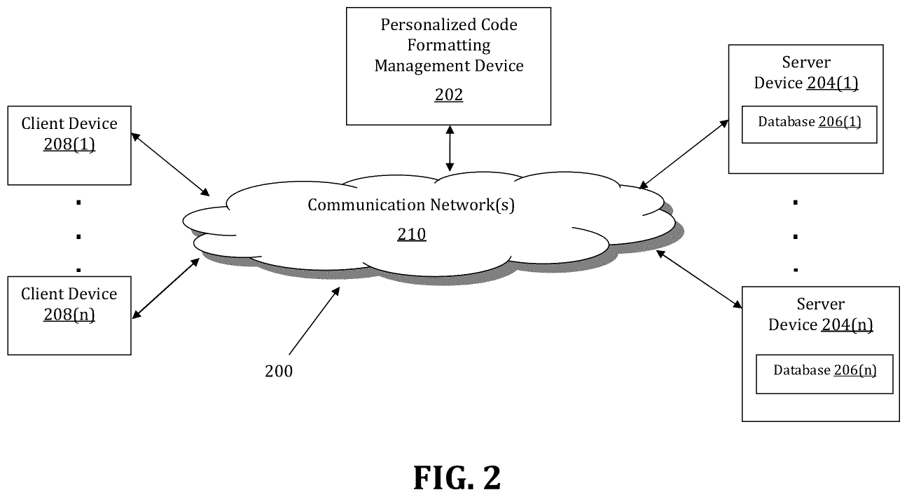

Referring to FIG. 2, a schematic of an exemplary network environment 200 for implementing a method for managing personalized code styling to provide custom code formatting for each developer in an integrated development environment is illustrated. In an exemplary embodiment, the method is executable on any networked computer platform, such as, for example, a personal computer (PC).

The method for managing personalized code styling to provide custom code formatting for each developer in an integrated development environment may be implemented by a Personalized Code Formatting Management (PCFM) device 202. The PCFM device 202 may be the same or similar to the computer system 102 as described with respect to FIG. 1. The PCFM device 202 may store one or more applications that can include executable instructions that, when executed by the PCFM device 202, cause the PCFM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PCFM device 202 itself, may be located in virtual server(s) running in a cloud-based computing environment rather than being tied to one or more specific physical network computing devices. Also, the application(s) may be running in one or more virtual machines (VMs) executing on the PCFM device 202. Additionally, in one or more embodiments of this technology, virtual machine(s) running on the PCFM device 202 may be managed or supervised by a hypervisor.

In the network environment 200 of FIG. 2, the PCFM device 202 is coupled to a plurality of server devices 204(1)-204(n) that hosts a plurality of databases 206(1)-206(n), and also to a plurality of client devices 208(1)-208(n) via communication network(s) 210. A communication interface of the PCFM device 202, such as the network interface 114 of the computer system 102 of FIG. 1, operatively couples and communicates between the PCFM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PCFM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PCFM devices that efficiently implement a method for managing personalized code styling to provide custom code formatting for each developer in an integrated development environment.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PCFM device 202 may be a standalone device or integrated with one or more other devices or apparatuses, such as one or more of the server devices 204(1)-204(n), for example. In one particular example, the PCFM device 202 may include or be hosted by one of the server devices 204(1)-204(n), and other arrangements are also possible. Moreover, one or more of the devices of the PCFM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PCFM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to user preferences, code styling preferences, code pull requests, code sets, display data sets, code upload requests, repository preferences, standard code styling preferences, and standard format data sets.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PCFM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PCFM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PCFM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PCFM device 202, the server devices 204(1)-204(n), or the client devices 208(1)-208(n), for example, may be configured to operate as virtual instances on the same physical machine. In other words, one or more of the PCFM device 202, the server devices 204(1)-204(n), or the client devices 208(1)-208(n) may operate on the same physical device rather than as separate devices communicating through communication network(s) 210. Additionally, there may be more or fewer PCFM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

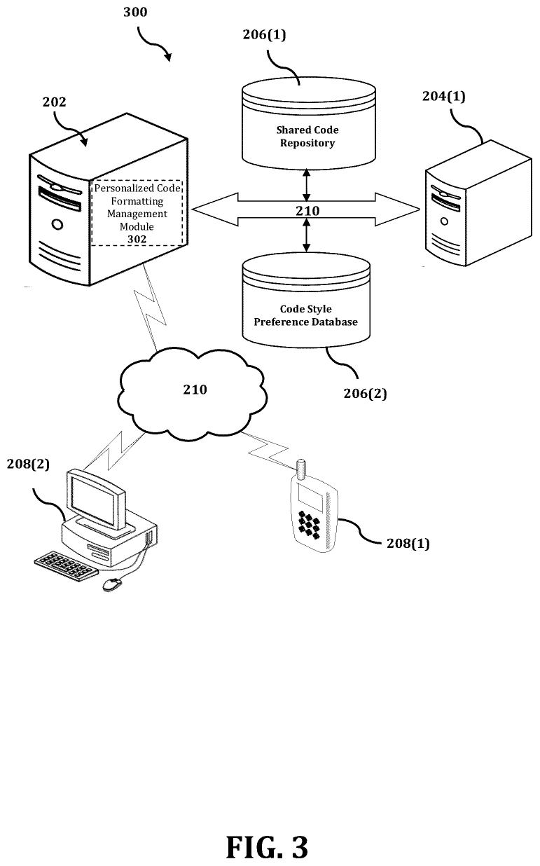

The PCFM device 202 is described and shown in FIG. 3 as including a personalized code formatting management module 302, although it may include other rules, policies, modules, databases, or applications, for example. As will be described below, the personalized code formatting management module 302 is configured to implement a method for managing personalized code styling to provide custom code formatting for each developer in an integrated development environment.

An exemplary process 300 for implementing a mechanism for managing personalized code styling to provide custom code formatting for each developer in an integrated development environment by utilizing the network environment of FIG. 2 is shown as being executed in FIG. 3. Specifically, a first client device 208(1) and a second client device 208(2) are illustrated as being in communication with PCFM device 202. In this regard, the first client device 208(1) and the second client device 208(2) may be “clients” of the PCFM device 202 and are described herein as such. Nevertheless, it is to be known and understood that the first client device 208(1) and/or the second client device 208(2) need not necessarily be “clients” of the PCFM device 202, or any entity described in association therewith herein. Any additional or alternative relationship may exist between either or both of the first client device 208(1) and the second client device 208(2) and the PCFM device 202, or no relationship may exist.

Further, PCFM device 202 is illustrated as being able to access a shared code repository 206(1) and a code style preference database 206(2). The personalized code formatting management module 302 may be configured to access these databases for implementing a method for managing personalized code styling to provide custom code formatting for each developer in an integrated development environment.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PCFM device 202 via broadband or cellular communication. Of course, these embodiments are merely exemplary and are not limiting or exhaustive.

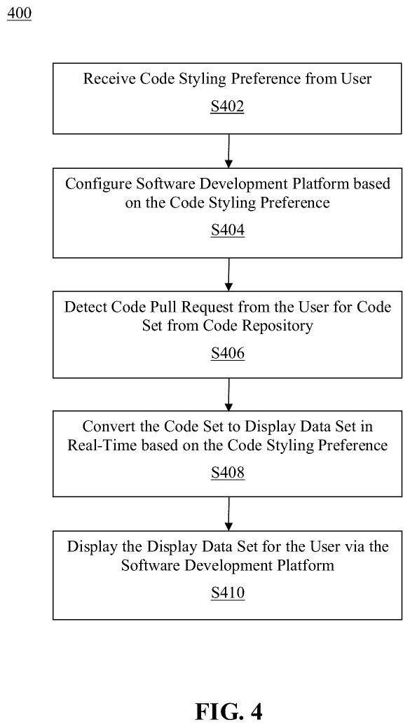

Upon being started, the personalized code formatting management module 302 executes a process for managing personalized code styling to provide custom code formatting for each developer in an integrated development environment. An exemplary data pull process for managing personalized code styling to provide custom code formatting for each developer in an integrated development environment is generally indicated at flowchart 400 in FIG. 4.

In the process 400 of FIG. 4, at step S402, preferences may be received from a first user. The preferences may be received via a graphical user interface. In an exemplary embodiment, the preferences may correspond to a code styling preference of the first user. The code styling preference may describe the layout and look of code, which does not affect the behavior of the code. For example, two pieces of code may behave identically but be vastly different stylistically. In another exemplary embodiment, the code styling preference may correspond to visual display preferences for presentation of the code on a user interface such as, for example, the graphical user interface. The code styling preference may include at least one from among an indentation preference, a spacing around operators preference, a blank lines preference, a comment lines preference, and a line length preference.

In another exemplary embodiment, the code may correspond to any collection of computing code such as, for example, source codes that lists commands to be executed by a computer program and/or computing device. The code may be written in a human-readable programming language as well as in a computer-readable programming language. In another exemplary embodiment, the code may include a single set of commands as well as a collection of several sets of commands for the computing device. Consistent with present disclosures, the code may be referenced as a code set and/or a software code.

In another exemplary embodiment, the first user may correspond to a user of a software development platform such as, for example, a software developer. The software developer may include computer programmers and software engineers who utilize the software development platform to generate the code. Consistent with present disclosures, the software developer may be referenced as a developer and/or a programmer.

In another exemplary embodiment, the preferences may be received via a graphical user interface that is associated with a software development platform such as, for example an integrated development environment (IDE). The graphical user interface may enable the first user to interact with the software development platform as well as provide user inputs. In another exemplary embodiment, the preferences may be received as a computer file such as, for example, a configuration file that stores data to be used by the computing device. For example, the preferences may be aggregated into a configuration file by a separate software application for use consistent with present disclosures.

In another exemplary embodiment, the preferences may be received from the first user via the graphical user interface by using interactive prompts. An initial set of prompts may be displayed for the first user via the graphical user interface. The graphical user interface may receive inputs from the first user in response to the initial set of prompts. The user may interact with graphical elements on the graphical user interface to provide the inputs. Then, whether additional information is required from the first user may be determined based on the received inputs. When additional information is required, subsequent prompts that correspond to the additional information may be displayed via the graphical user interface for the first user. Multiple rounds of inputs and subsequent prompts may be required to gather the necessary information from the first user.

At step S404, a software development platform that corresponds to the first user may be configured based on the preferences. In an exemplary embodiment, the preferences may be parsed to identify parameters related to the layout and look of the code. For example, the preferences may include specific spacing parameters for the indentation of code for organization into a predetermined hierarchy. In another exemplary embodiment, the software development platform that corresponds to the first user may be determined based on a characteristic of the first user such as, for example, a first user identifier. For example, when the first user provides the preferences via a separate software application, the software development platform may be identified for configuring based on a login of the first user on the software development platform.

In another exemplary embodiment, several software development platforms that correspond to the first user may be automatically configured. To facilitate the configuring, the preferences may be associated with the first user. The preferences may be associated with a collection of settings and information such as, for example, a user profile that corresponds to the first user. Then, usage of a new software development platform by the first user may be automatically detected. The automated detection process may use a user login of the first user to make the determination. Finally, the new software development platform may be automatically configured for the first user based on the preferences.

At step S406, code pull requests from the first user may be detected. The code pull requests may include a first request to pull a code set from a code repository to the software development platform. In an exemplary embodiment, the code repository may correspond to a storage device that enables the persistence of computing code. The code repository may include a shared code repository that is accessible by a plurality of developers. In another exemplary embodiment, the code pull request may relate to the retrieval of a code set from the code repository by the first user. For example, the code pull request may relate to an action by the user to open a code set on the software development platform.

At step S408, the code set may be converted to a display data set based on the preferences. The code set may be automatically converted in real-time in response to detection of the code pull request. In an exemplary embodiment, a translation tool may be automatically initiated to facilitate the conversion. The translation tool may correspond to a piece of software that is usable to transform input into a specified output. The translation tool may be an integrated component of the software development platform as well as a separately operable component that is connected to the software development platform and the code repository via an enterprise network environment.

In another exemplary embodiment, the code set may be converted to the display data set by first identifying the translation tool that corresponds to the software development platform. Consistent with present disclosures, the translation tool may be identified from a plurality of translation tools. The translation tool may be identified based on the preferences of the first user and characteristics of the code set. The characteristics of the code set may include a code type characteristic. For example, the translation tool for a particular code set may be identified based on the programming language of the code set to ensure compatibility.

Further, the code set may be parsed to identify elements. The elements may relate to at least one from among an alphanumeric character, a spacing character, and a symbol that make up the code set. Language processing techniques such as, for example, a natural language processing technique may be used to facilitate the parsing of the code set and the identification of the elements. Then, each of the elements may be mapped via the identified translation tool. Mapping of the elements may identify functionalities for each of the elements in the code set to ensure that the behavior of the code set is preserved. Finally, the display data set may be generated via the identified translation tool based on a result of the mapping and the preferences. Consistent with present disclosures, the display data set may be visually different from the code set while maintaining similar functionalities.

In another exemplary embodiment, a log file may be generated based on a result of the conversion. The log file may include information that relates to at least one from among the identified translation tool, the at least one element, the mapping, and the generated display data set. Then, the log file may be associated together with the first user. The log file may be usable to document the conversion process to enable subsequent review by the first user and/or an administrator. As will be appreciated by a person of ordinary skill in the art, the log file and the documentation allow for a transparent conversion process.

At step S410, the display data set may be displayed via the software development platform for the first user. The display data set may be displayed for the user in response to the code pull request. In an exemplary embodiment, the first user configures a preferred style preference, and all future code will be displayed to the first user in the configured/preferred coding style. The future code will be displayed to the first user in the configured/preferred coding style regardless of the style in which it was originally written and persisted. Correspondingly, any code that is written by the first user that is later viewed by another user will be displayed to the other user in a preferred style associated with the other user.

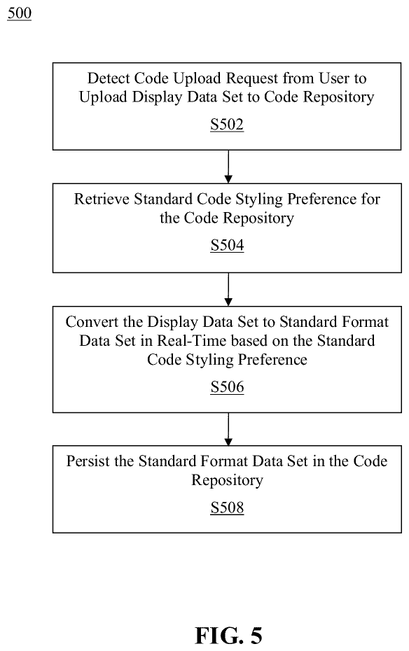

FIG. 5 is a flowchart 500 of an exemplary data upload process for implementing a method for managing personalized code styling to provide custom code formatting for each developer in an integrated development environment.

In the process 500 of FIG. 5, at step S502, a code upload request from the first user may be detected. The code upload request may include a second request to upload the display data set from the software development platform to the code repository. In an exemplary embodiment, the code repository may correspond to a storage device that enables the persistence of computing code. The code repository may include a shared code repository that is accessible by a plurality of developers. In another exemplary embodiment, the code upload request may relate to the uploading and/or persisting of the display data set from the software development platform by the first user. For example, the code upload request may relate to an action by the user to save the display data set to the code repository.

At step S504, repository preferences may be retrieved from the code repository. The repository preferences may correspond to a standard code styling preference of the code repository. In an exemplary embodiment, the repository preferences may be predetermined for a particular project. For example, the repository preferences for project A may be different than the repository preferences for project B. In another exemplary embodiment, the repository preferences may be predetermined for an entire organization. For example, every project that is persisted in the code repository must adhere to the repository preferences.

In another exemplary embodiment, the repository preferences may be inferred from the code pull conversion process. For example, the repository preferences may be identified from the code set during the code pull conversion process so that a code upload conversion process may be accomplished in reverse.

At step S506, the display data set may be converted to a standard format data set. The display data set may be automatically converted in real-time based on the repository preferences. Consistent with present disclosures for the code pull conversion process, the code upload conversion process may be facilitated by using a translation tool. Then, at step S508, the standard format data set may be persisted in the code repository.

In another exemplary embodiment, a second user such as, for example, an administrator may choose a standard style that will be the style that the code repository exists in. A new standard code styling preference may be received from the second user via the graphical user interface. The new standard code styling preference may relate to a code format that is determined based on at least one from among a business guideline, an operational guideline, and a regulatory guideline. Then, the repository preference of the code repository may be automatically updated based on the new standard code styling preference.

Accordingly, with this technology, an optimized process for managing personalized code styling to provide custom code formatting for each developer in an integrated development environment is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for managing personalized code formatting to facilitate collaborative software development, the method being implemented by at least one processor, the method comprising:
receiving, by the at least one processor via a graphical user interface, at least one preference from a first user, the at least one preference corresponding to a code styling preference of the first user;
configuring, by the at least one processor, a software development platform that corresponds to the first user based on the at least one preference;
detecting, by the at least one processor, at least one code pull request from the first user, the at least one code pull request including a first request to pull a code set from a code repository to the software development platform;
converting, by the at least one processor in real-time, the code set to a display data set based on the at least one preference; and
displaying, by the at least one processor via the software development platform, the display data set for the first user.

2. The method of claim 1, further comprising:
detecting, by the at least one processor, at least one code upload request from the first user, the at least one code upload request including a second request to upload the display data set from the software development platform to the code repository;
retrieving, by the at least one processor, at least one repository preference from the code repository, the at least one repository preference corresponding to a standard code styling preference of the code repository;
converting, by the at least one processor in real-time, the display data set to a standard format data set based on the at least one repository preference; and
persisting, by the at least one processor, the standard format data set in the code repository.

3. The method of claim 2, further comprising:
receiving, by the at least one processor via the graphical user interface, a new standard code styling preference from a second user, the new standard code styling preference relating to a code format that is determined based on at least one from among a business guideline, an operational guideline, and a regulatory guideline; and
automatically updating, by the at least one processor, the at least one repository preference of the code repository based on the new standard code styling preference.

4. The method of claim 1, wherein receiving the at least one preference from the first user via the graphical user interface further comprises:
displaying, by the at least one processor via the graphical user interface, at least one prompt for the first user;
receiving, by the at least one processor via the graphical user interface, at least one input from the first user in response to the at least one prompt;
determining, by the at least one processor, whether additional information is required from the first user based on the at least one input; and
displaying, by the at least one processor via the graphical user interface, at least one subsequent prompt for the first user when additional information is required.

5. The method of claim 1, wherein converting the code set to the display data set further comprises:
identifying, by the at least one processor, at least one translation tool that corresponds to the software development platform from a plurality of translation tools;
parsing, by the at least one processor, the code set to identify at least one element, the at least one element relating to at least one from among an alphanumeric character, a spacing character, and a symbol that make up the code set;
mapping, by the at least one processor via the identified at least one translation tool, each of the at least one element; and
generating, by the at least one processor via the identified at least one translation tool, the display data set based on a result of the mapping.

6. The method of claim 5, wherein the at least one translation tool is identified based on the at least one preference of the first user and at least one characteristic of the code set, the at least one characteristic including a code type characteristic.

7. The method of claim 5, further comprising:
generating, by the at least one processor, at least one log file, the at least one log file including information that relates to at least one from among the identified translation tool, the at least one element, the mapping, and the generated display data set; and
associating, by the at least one processor, the at least one log file together with the first user.

8. The method of claim 1, wherein the code styling preference includes at least one from among an indentation preference, a spacing around operators preference, a blank lines preference, a comment lines preference, and a line length preference.

9. The method of claim 1, further comprising:
associating, by the at least one processor, the at least one preference with the first user;
automatically detecting, by the at least one processor based on a user login, usage of a new software development platform by the first user; and
automatically configuring, by the at least one processor, the new software development platform for the first user based on the at least one preference.

10. A computing device configured to implement an execution of a method for managing personalized code formatting to facilitate collaborative software development, the computing device comprising:
a processor;
a memory; and
a communication interface coupled to each of the processor and the memory,
wherein the processor is configured to:
receive, via a graphical user interface, at least one preference from a first user, the at least one preference corresponding to a code styling preference of the first user;
configure a software development platform that corresponds to the first user based on the at least one preference;
detect at least one code pull request from the first user, the at least one code pull request including a first request to pull a code set from a code repository to the software development platform;
convert, in real-time, the code set to a display data set based on the at least one preference; and
display, via the software development platform, the display data set for the first user.

11. The computing device of claim 10, wherein the processor is further configured to:
detect at least one code upload request from the first user, the at least one code upload request including a second request to upload the display data set from the software development platform to the code repository;
retrieve at least one repository preference from the code repository, the at least one repository preference corresponding to a standard code styling preference of the code repository;
convert, in real-time, the display data set to a standard format data set based on the at least one repository preference; and
persist the standard format data set in the code repository.

12. The computing device of claim 11, wherein the processor is further configured to:
receive, via the graphical user interface, a new standard code styling preference from a second user, the new standard code styling preference relating to a code format that is determined based on at least one from among a business guideline, an operational guideline, and a regulatory guideline; and
automatically update the at least one repository preference of the code repository based on the new standard code styling preference.

13. The computing device of claim 10, wherein, to receive the at least one preference from the first user via the graphical user interface, the processor is further configured to:
display, via the graphical user interface, at least one prompt for the first user;
receive, via the graphical user interface, at least one input from the first user in response to the at least one prompt;
determine whether additional information is required from the first user based on the at least one input; and
display, via the graphical user interface, at least one subsequent prompt for the first user when additional information is required.

14. The computing device of claim 10, wherein, to convert the code set to the display data set, the processor is further configured to:
identify at least one translation tool that corresponds to the software development platform from a plurality of translation tools;
parse the code set to identify at least one element, the at least one element relating to at least one from among an alphanumeric character, a spacing character, and a symbol that make up the code set;
map, via the identified at least one translation tool, each of the at least one element; and
generate, via the identified at least one translation tool, the display data set based on a result of the mapping.

15. The computing device of claim 14, wherein the processor is further configured to identify the at least one translation tool based on the at least one preference of the first user and at least one characteristic of the code set, the at least one characteristic including a code type characteristic.

16. The computing device of claim 14, wherein the processor is further configured to:
generate at least one log file, the at least one log file including information that relates to at least one from among the identified translation tool, the at least one element, the mapping, and the generated display data set; and
associate the at least one log file together with the first user.

17. The computing device of claim 10, wherein the code styling preference includes at least one from among an indentation preference, a spacing around operators preference, a blank lines preference, a comment lines preference, and a line length preference.

18. The computing device of claim 10, wherein the processor is further configured to:
associate the at least one preference with the first user;
automatically detect, based on a user login, usage of a new software development platform by the first user; and
automatically configure the new software development platform for the first user based on the at least one preference.

19. A non-transitory computer readable storage medium storing instructions for managing personalized code formatting to facilitate collaborative software development, the storage medium comprising executable code which, when executed by a processor, causes the processor to:
receive, via a graphical user interface, at least one preference from a first user, the at least one preference corresponding to a code styling preference of the first user;
configure a software development platform that corresponds to the first user based on the at least one preference;
detect at least one code pull request from the first user, the at least one code pull request including a first request to pull a code set from a code repository to the software development platform;
convert, in real-time, the code set to a display data set based on the at least one preference; and
display, via the software development platform, the display data set for the first user.

20. The storage medium of claim 19, wherein, when executed by the processor, the executable code further causes the processor to:
detect at least one code upload request from the first user, the at least one code upload request including a second request to upload the display data set from the software development platform to the code repository;
retrieve at least one repository preference from the code repository, the at least one repository preference corresponding to a standard code styling preference of the code repository;
convert, in real-time, the display data set to a standard format data set based on the at least one repository preference; and
persist the standard format data set in the code repository.
